(19) United States
(12) Patent Application Publication
(10) Pub. No.: US 2014/0081751 A1
(43) Pub. Date: Mar. 20, 2014

(54) COMPUTERIZED SYSTEMS AND METHODS FOR MARKETING VEHICLE FINANCING OFFERS

(71) Applicant: Claremont Financial Services, Inc., (US)

(72) Inventors: Roger Hogan, Claremont, CA (US); Kyle Hogan, Claremont, CA (US)

(73) Assignee: CLAREMONT FINANCIAL SERVICES, INC., Claremont, CA (US)

(21) Appl. No.: 13/651,375

(22) Filed: Oct. 12, 2012

Related U.S. Application Data
(60) Provisional application No. 61/546,951, filed on Oct. 13, 2011.

(51) Int. Cl. G06Q 30/02

(52) U.S. Cl. CPC G06Q 30/0255; G06Q 40/025
USPC 705/14.53

(57) ABSTRACT

A machine-implemented method for generating financing offers to a customer is disclosed. A plurality of original loan variables, including an original periodic payment amount, an original loan remaining duration, an original loan balance, and an original loan interest rate for an open loan account associated with the customer is received. A proposed interest rate is derived at least partially from prevailing market rates, and a proposed remaining loan duration is received. A plurality of proposed loan variables, including a proposed periodic payment amount and a proposed payoff amount is generated from the original loan balance and at least one of the proposed interest rate and the proposed remaining loan duration. Proposed difference values are generated based upon a comparison of the proposed loan variables and the original loan variables.

### CROSS-REFERENCE TO RELATED APPLICATIONS

This application relates to and claims the benefit of U.S. Provisional Patent Application No. 61/546,951 filed Oct. 13, 2011 and entitled METHOD FOR SELLING AND REFINANCING VEHICLES, the entirety of the disclosure of which is wholly incorporated by reference herein.

### STATEMENT RE: FEDERALLY SPONSORED RESEARCH/DEVELOPMENT

Not Applicable

### BACKGROUND

1. Technical Field

The present disclosure relates generally to information management in the automotive sales industry. More particularly, the present disclosure relates to computerized systems and methods for marketing vehicle financing offers including re-financing open loans, and sales of replacement or additional vehicles.

2. Related Art

Automobiles permeate virtually every aspect of daily life in most developed countries except for the few major cities with robust public transportation systems, and are relied upon for going to and from work, school, shopping, leisure activities and countless other destinations. By some estimates, there are around 600 million automobiles in service worldwide, with various manufacturers producing a total of some 70 million units annually. Over its development history, automobiles have evolved from basic machines comprised of little more than wheels and a propulsion source on a frame, to sophisticated systems with numerous features that improve safety, efficiency, driving experience, and passenger comfort.

Although automobiles are essential for living in many parts of the world, and notwithstanding high production numbers by various manufacturers in a competitive marketplace, typical retail prices are more than what consumers can pay in a lump sum. With the exception of wealthy individuals or those who have saved up to an extent an automobile can be purchased outright with cash, most consumers opt for financing.

Over history, a specific retail environment that is peculiar to automotive sales has evolved. Conventionally, independent dealerships purchase automobiles at various wholesale prices from the manufacturer. The dealerships maintain stocks of different models that are offered for sale to the purchasing public. Each dealership for a given manufacturer may cover a specific territory or region so as to minimize the possibility of over-saturating a local market that leads to artificially low prices, while also meeting demand. The dealerships have some degree of flexibility with regard to the final purchase price, and are able to negotiate deals with customers that strike a mutually agreeable balance between the dealerships' need to maintain profitability and the purchasers' need to minimize prices.

Again, with the price of typical cars being outside the wherewithal of most consumers to pay at once, financing is an attractive option. The dealership itself, however, is oftentimes not the funding source/financer. Some purchasers may opt to obtain loans from their own banks and credit unions with which they may have a pre-existing business relationship. The total loan amounts, loan duration, interest rates, repayment terms and the like are pre-approved, and the purchaser merely negotiates the final purchase price of the automobile. Almost all manufacturers also have financing divisions or companies, which dealers may call upon to finance transactions for its customers. As with the pricing of the automobile, there may be flexibility in setting the financing terms, and accordingly can be another point of negotiation with the customer. Depending on the creditworthiness and financial resources of the customer, varying interest rates, loan duration, monthly payment amounts, and the like can be negotiated by the dealer on behalf of the finance company. In some situations, dealers may solicit loans from multiple financing companies on behalf of the consumer, not just from the manufacturer-affiliated finance company.

Once the transaction is finalized, the customer is obligated to begin repayment of the loan on the agreed-upon terms. Thus, even if prevailing market interest rates decrease, or if the financial situation of the customer changes to such an extent that interest rates for other borrowers of similar creditworthiness would otherwise justify lower interest rates and thus lower total loan costs, the customer may remain tied to those less favorable terms. Furthermore, under conventional purchasing/financing options, even if the customer desires to upgrade or change vehicles, they may not be able to because of the existing financing and repayment obligations for the existing vehicle, and the encumbrances placed thereon as part of such obligations.

Where the loan terms may allow such modifications, it is oftentimes difficult for the consumer to make well-informed decisions on whether it would be financially beneficial and/or justified. At any given point in the loan term, it would be necessary to ascertain residual loan repayment amounts, the fair market value and the dealer resale value of the existing vehicle, and so forth. Accordingly, the customer typically merely goes on fulfilling the obligations as originally negotiated despite any financial and life circumstances that may have changed over time. In many cases, it would be advantageous for the dealer to offer better financing terms as they become available for purposes of customer retention and building goodwill. Of course, any opportunity to make additional vehicle sales when it can benefit the customer is desirable.

Currently, there is no known way to identify and communicate with existing customers for whom refinancing or replacing the vehicle can be advantageous. Accordingly, there is a need in the art for computerized methods and systems for marketing vehicle financing offers.

### BRIEF SUMMARY

The present disclosure contemplates various modalities for generating financing offers to customers. These modalities find particular applicability to the retail vehicle sales environment, i.e., car dealerships, where the refinancing of open auto loans and the financing of additional car purchases is envisioned. The dealership can thus become a financing hub for vehicles of nearly all makes and models, thereby improving customer service and increasing customer retention, while concurrently improving revenue. Additionally, consumers can benefit through lower interest rates, lowered monthly payments, and gaining equity in the vehicles faster.

In accordance with one embodiment, there a machine-implemented method for generating financing offers to a customer is contemplated. The method may include receiving a plurality of original loan variables for an open loan account associated with the customer. The original loan variables may include an original periodic payment amount, an original loan remaining duration, an original loan balance, and an original loan interest rate. There may be a step of deriving a proposed interest rate based partially upon prevailing market rates, as well as a step of receiving a proposed remaining loan duration. The method may further include generating a plurality of proposed loan variables based upon the original loan balance and at least one of the proposed interest rate and the proposed remaining loan duration. The plurality of proposed loan variables may include a proposed periodic payment amount and a proposed payoff amount. Additionally, there may be a step of generating proposed difference values from a comparison of the proposed loan variables and the original loan variables. One of the proposed difference values may be a periodic payment amount difference of a comparison between the proposed periodic payment amount and the original periodic payment amount. Another one of the proposed difference values may be loan savings amount of a comparison between the proposed payoff amount and the original loan balance. This method may be implemented as a series of computer-executable instructions included in a non-transitory computer readable medium according to different embodiments of the present disclosure.

According to another embodiment, a system for generating financing offers is contemplated. The system may include an original loan data input segment that can be generated on a computer user interface. This interface may be receptive to user inputs. The original loan data input segment may include input elements for original loan data of an open loan account including at least one of an original periodic payment amount, an original remaining loan duration, an original loan balance, and an original loan interest rate. The system may further include a proposed loan data output segment also generated on the computer user interface. The proposed loan data output segment may have output elements for at least one of a proposed interest rate, a proposed remaining loan duration, a proposed periodic payment amount and a proposed payoff amount that are calculated in response to the input of the original loan data. There may additionally be a difference output segment likewise generated on the computer user interface. The difference output segment may include output elements for a periodic payment amount difference and a loan savings amount that are displayed in response to the input of the original loan data. The proposed remaining loan duration and proposed interest rate may be derived at least partially from prevailing market rates. The proposed periodic payment amount and the proposed payoff amount may be derived from the proposed interest rate and the original loan balance.

The present disclosure additionally contemplates a method for marketing vehicle financing offers to a plurality of customers. The method may include querying a local dealer management system database for a plurality of sales records of customers. At least one of the queried sales records may be linked to open loan accounts associated with respective ones of the customers. Each open loan account may have a plurality of original loan variables including at least one of an original periodic payment amount, an original loan remaining duration, an original loan balance, and an original loan interest rate. The method may also include retrieving the open loan accounts with one or more original loan variables matching a predetermined criterion. There may additionally be a step of deriving a proposed interest rate based partially upon prevailing market rates. Then, the method may continue with generating a plurality of proposed loan variables based upon the original loan balance and at least one of the proposed interest rate and a proposed remaining loan duration. The plurality of proposed loan variables may include a proposed periodic payment amount and a proposed payoff amount. The method may include retrieving customer contact data from the sales records associated with the retrieved open loan accounts, as well as generating a promotional document for the customers that correspond to the retrieved open loan accounts. The promotional document may include the plurality of original loan variables and the plurality of proposed loan variables.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a block diagram illustrating a typical automotive retail environment including dealerships, lenders, customers, and credit bureaus, in which various embodiments of the present disclosure may be implemented;

FIG. 2 is a block diagram of an example dealer management system implementation including the components thereof that may be utilized in conjunction with various features of the presently disclosed methods and system for marketing vehicle financing offers;

FIG. 3 is a flowchart showing the steps of one contemplated method for marketing vehicle financing offers to a plurality of customers;

FIG. 4A is a first embodiment of a promotional document sent to the customers;

FIG. 4B is a second embodiment of the promotional document sent to the customers;

FIG. 5 is an example user interface for a software application implementing certain aspects of a method for generating financing offers to the customer, generally divided into a refinancing deal structuring segment and a contract structuring segment;

FIG. 6 is a flowchart showing the steps of the machine-implemented method for generating financing offers;

FIG. 7A is an excerpt of the user interface showing a first workspace of the refinancing deal structuring segment in which original loan variables may be input;

FIG. 7B is another excerpt of the user interface showing a second workspace of the refinancing deal structuring segment in which a rate comparison may be demonstrated;

FIG. 7C is yet another excerpt of the user interface showing a third workspace of the refinancing deal structuring segment in which a term comparison may be demonstrated;

FIG. 7D is still another excerpt of the user interface showing a fourth workspace of the refinancing deal structuring segment in which a rebate comparison may be demonstrated;

FIG. 8A is an excerpt of the contract structuring segment of the user interface with a first workspace thereof for inputting basic borrower information;

FIG. 8B is an excerpt of the contract structuring segment of the user interface with a second workspace thereof for itemizing various offsets of the proposed transaction;

FIG. 8C is an excerpt of the contract structuring segment of the user interface with a third workspace thereof for inputting security interest information;

FIG. 8D is an excerpt of the contract structuring segment of the user interface with a fourth workspace thereof for inputting basic financing information;

FIG. 8E is an excerpt of the contract structuring segment of the user interface with a fifth workspace thereof for summarizing the proposed loan terms; and

FIG. 8F is an excerpt of the contract structuring segment of the user interface with a sixth workspace thereof for inputting certain application-wide variables that are used for every refinancing transaction.

Common reference numerals are used throughout the drawings and the detailed description to indicate the same elements.

### DETAILED DESCRIPTION

The detailed description set forth below in connection with the appended drawings is intended as a description of certain embodiments of facilitating financing offers to customers, along with various methods and systems directed to that end. It is not intended to represent the only forms that may be developed or utilized. The description sets forth various functions in connection with the illustrated embodiments, but it is to be understood, however, that the same or equivalent functions may be accomplished by different embodiments that are also intended to be encompassed within the scope of the present disclosure. It is further understood that the use of relational terms such as first and second and the like are used solely to distinguish one entity from another without necessarily requiring or implying any actual such relationship or order between such entities.

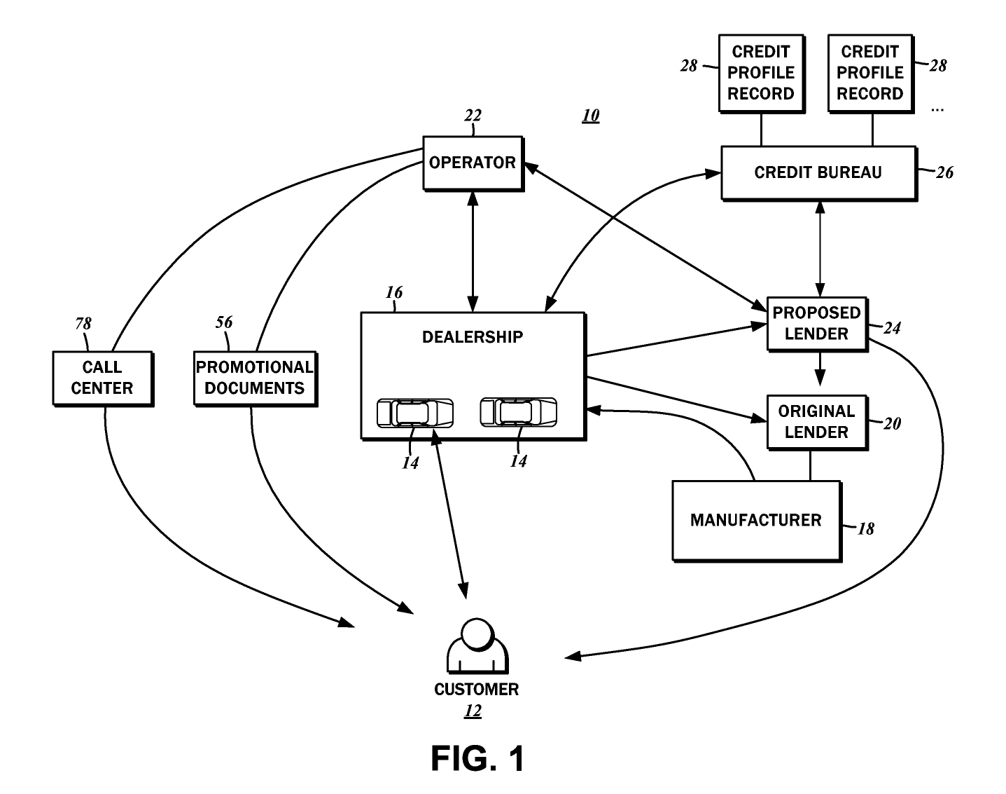

Referring now to the block diagram of FIG. 1, there is a simplified depiction of a typical automotive retail environment 10 in which various embodiments of the present disclosure may be implemented. In this regard, although various features are referenced and discussed relative to the automotive retail environment, it is expressly contemplated that those features are also applicable in other retail sales contexts. Those having ordinary skill in the art will recognize the needed modifications to those features discussed herein that adapt the same to such alternative contexts.

A customer 12 in most cases purchases a car 14 from a dealership 16, which itself purchases the car 14 from a manufacturer 18. The manufacturer 18, in industry parlance, is also oftentimes referred to as the factory. The dealership 16 is largely independent of the manufacturer 18, though selling procedures and other operational specifics may be dictated thereby. The manufacturer 18 sells the car 14 to the dealership 16 at a dealer cost. Various personnel are employed by the dealership 16 to promote the cars 14 and the manufacturer 18, and to facilitate the sales transaction with the customer 12. To compensate such personnel, as well as to deliver a level of profitability that would justify the continuity of an independently operated business concern, the dealership 16 may add a nominal markup to the purchase price offered to the customer 12.

Because most customers 12 do not have the financial resources to pay for the car 14 at once, a part of the purchase price may have been borrowed from a lender 20. The lender 20 is likewise independent of the dealership 16, though oftentimes it is a division of the manufacturer 18, or is another similarly affiliated entity. At the time of making the purchase, various terms of the sales transaction and the loan are negotiated, including the total purchase price of the car 14 including taxes, license fees, and the like, the interest rate of the loan, the total duration of the loan, and the amount of each periodic (typically monthly) payment. Once the customer 12 takes possession of the car 14, the dealership 16 is reimbursed by the lender 20 for the negotiated purchase price, and the customer 12 begins making payments per the terms of the loan. The lender 20 retains title to the car 14 until the entire debt amount, plus interest and costs, are paid back to the lender 20.

The marketing of refinancing offers for such open loans, as well as offers for new vehicle loans that subsume and refinance existing open loans, is contemplated in accordance with the present disclosure. For example, the economic climate may have changed since the customer 12 purchased the car 14, and prevailing interest rates may be lower. Additionally, the personal circumstances of the customer 12 may have improved over time, with increased creditworthiness that would qualify the customer 12 for a lower interest rate. In some cases, the customer 12 may merely desire to exchange the car 14 for another, later model (either new or used) out of personal desire, even though the loan for the originally purchased car 14 has not yet terminated. As referenced herein, the term “refinance” is understood to encompass any transaction involving the replacement of existing debt obligations for another, including the modification of interest and/or remaining loan duration terms of existing loans, adding previous debt to a new loan under a different duration and/or interest, and so forth.

The present disclosure envisions computerized systems and various methods for marketing to these types of customers who may be interested or could benefit from refinancing open auto loans. Dealership personnel can help budget the customer 12 for new purchases while lowering costs of the open loan, as well as lower existing monthly payments or assisting the customer 12 in gaining equity in the car 14 more quickly. These subsequent loans may be offered by a proposed lender 24, which may be different from the original lender 20. Although only a single proposed lender 24 is shown in the block diagram of FIG. 1, several other lenders may also be involved, with competitive interest rates and terms among such lenders being available for selection by the customer 12.

In one embodiment, there is an operator 22 that provides some parts of these services. The dealership 16 typically does not have specialized lending personnel on staff, and so the operator 22 may provide assistance with lending practices and strategies, particularly refinancing contracts. With such instruction and training, it may be possible for existing staff to act as an agent on behalf of the proposed lender and be available to handle the contemplated loan refinancing transactions on-site at the dealership 16. The instruction may be provided via live-presentation by those under the employ of or otherwise affiliated with the operator 22, or via written materials presented in a self-study format. The operator 22 may also assist with establishing a business relationship with the proposed lender 24, including the preparation and execution of any written agreements therefor. In some embodiments where multiple proposed lenders 24 are contemplated, it may be necessary for the dealership 16 to retain personnel who are duly licensed as brokers.

As a part of offering what is effectively a new loan, the proposed lender 24 evaluates the creditworthiness/credit risk of the customer 12. Accordingly, the dealership 16 may runs a credit check through a credit bureau 26. It is understood that the credit bureau 26 maintains credit profile records 28 of any individual who has requested and has been extended any type of loan or credit. Presumably, the customer 12, having an existing open loan, is associated with a unique credit profile record 28. It is understood that the credit profile record 28 include various information on, including, without limitation, all open consumer loans, mortgages, credit cards. Details pertaining to each of these open credit accounts are also recorded in the credit profile record 28, including the current remaining balance, payment history, any delinquencies, account age, highest balance, total credit extended, and so forth. All such factors may be aggregated and weighted according to proprietary algorithms, with the most widely used being the FICO score. This creditworthiness score is reported by all consumer-oriented credit bureaus including TransUnion, Equifax, and Experian.

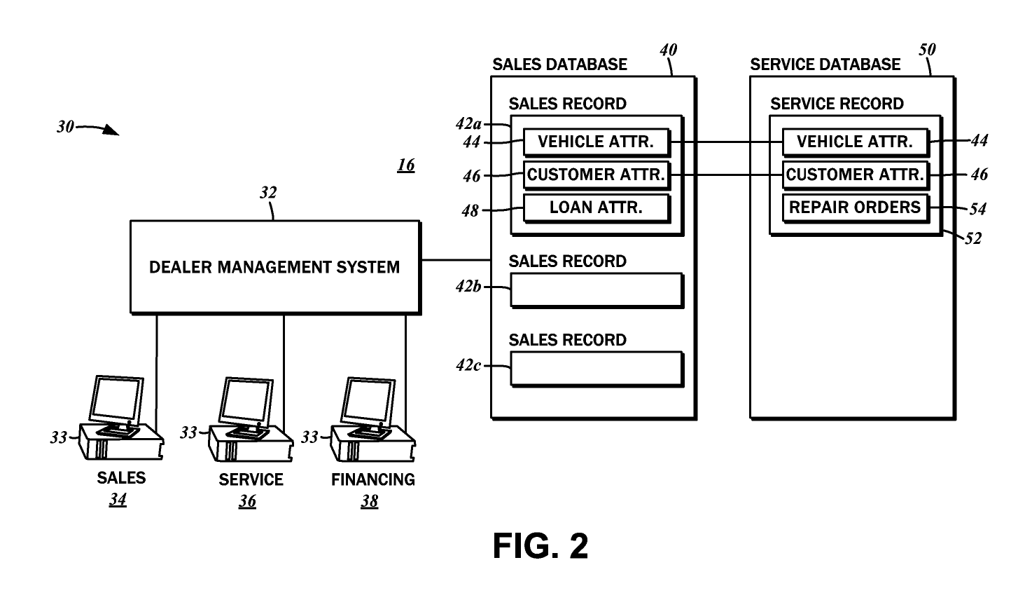

Referring now to the block diagram of FIG. 2, a typical information technology (IT) environment 30 of the dealership 16 may be centered on a dealer management system 32 that records data on all aspects of dealership operation, including a sales department 34, a service department 36, as well as a financing department 38, among others not shown. The dealer management system 32 may additionally have vehicle inventory management and tracking features, accounting features, sales and employee commission tracking features, parts inventory management and tracking features, and appointment scheduling features. The dealer management system 32 is understood to be a server application or a collection of individual software modules to which various computer terminals 33 associated with the departments 34-38 of the dealership 16 operation are connected. There are several commercially available variations of the dealer management system 32, and any may be substituted without departing from the scope of the present disclosure. Data entry and review interfaces are provided on the computer terminals 33 to facilitate the respective business operations of the departments.

As pertinent to the present disclosure, the dealer management system 32 stores, in a sales database 40, sales records 42 of all purchase transactions made through the dealership 16. Each of the sales records 42 may have associated therewith a set of vehicle identification attributes 44 that details the model, year, color, optional accessories, and other related information pertaining to the car 14. There is also a set of customer identification attributes 46 including the name, mailing address, telephone number, and email address of the customer 12 purchasing the car 14 identified by the vehicle identification attributes 44. Furthermore, there is a set of financing attributes 48 that detail the total sale price, loan amount, monthly payment amount, and interest rate of the purchased car 14. It is understood that the foregoing data is entered at the time the sales transaction is completed. The information included in the sales record 42 is presented by way of example only and not of limitation, and any other suitable and useful data may be stored.

In addition to the sales database 40, the service department 36 may also maintain a service database 50 including service records 52 of the customers 12. Again, the service records 52 may include the vehicle identification attributes 44 and the customer identification attributes 46, and the service records 52 and the sales record 42 may be logically linked therewith. The service records 52 may also include links 54 to repair orders that further specify the nature of the services previously performed on the car 14 to which it pertains. Both the sales database 40 and the service database 50 can be utilized in different ways to initiate interactions with the customer 12 to present refinancing and vehicle sales financing offers.

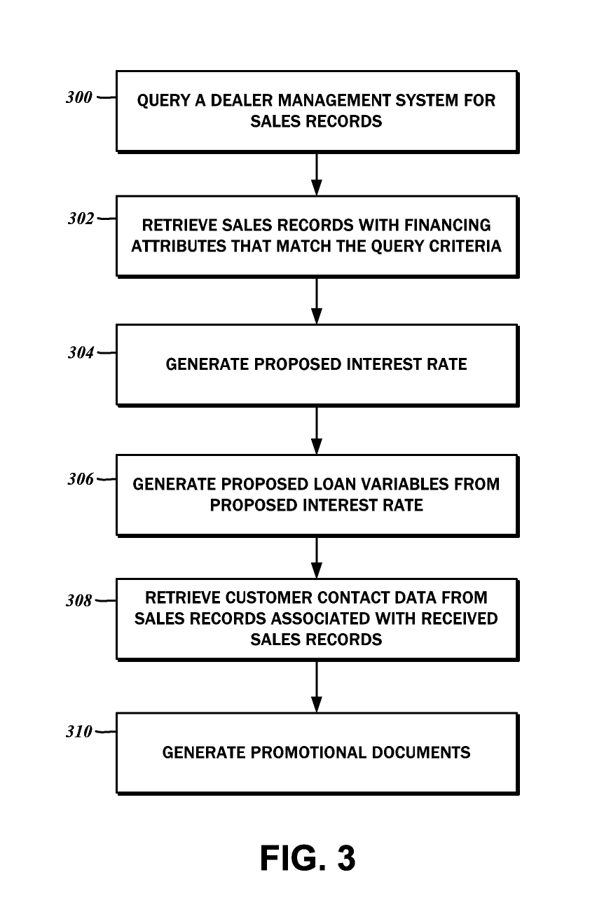

With reference to the flowchart of FIG. 3, one of the contemplated ways in which potential refinancing or new vehicle purchase financing customers 12 can be solicited may begin with a step 300 querying the dealer management system 32, and specifically the sales database 40 thereof for a plurality of sales records 42. As indicated above, the sales records 42 may be linked to open loan accounts associated with different customers, with each open loan account as specified by the financing attributes 48 in the sales records 42 including at least one of an original periodic payment amount (i.e., the monthly payment amount), an original loan remaining duration, an original loan balance, and an original loan interest rate.

The query may specify various criteria for the financing attributes 48 corresponding to the sales records 42, including total loan amounts that exceed a predetermined value, an interest rate that exceed a predetermined value, a remaining term in the loan, and so forth. In accordance with the present disclosure, the criteria may be tailored to identify customers 12 who would particularly benefit from lower interest rates and/or a further extension of the loan duration. The criteria may also encompass customers 12 who may potentially be desirous of acquiring another car 14 or replacing an existing one while retiring the original loan, and subsequently acquiring a new loan. Thus, loans with higher than prevailing interest rates, or those with more than half of the total duration remaining are understood to be potential candidates. The use of the systems and methods is understood to be advantageous from the perspective of the dealership 16, as marketing can be targeted to those customers 12 with the highest likelihood of purchasing a new car or refinancing an open loan.

The method may continue with a step 302 of retrieving the open loan accounts, that is, the sales records 42 with the financing attributes 48 matching the specified criteria. Preferably, the proposed lender 24 would make refinancing offers only to those customers 12 with a proven track record of reliable, timely payment, so sales records 42 with corresponding open loan accounts with no current or past delinquencies may be retrieved.

The source of the open loan accounts need not be limited to that which can be retrieved via the dealer management system 32. For instance, paper files containing the sales records of past transactions can also be searched. According to another embodiment, this information may be retrieved from the credit bureau 26. In addition the standard creditworthiness information for individuals, the credit bureau 26 offers a pre-screening service that provides contact information and certain specifics of associated open loan accounts and credit usage history for customers whose profiles match specified criteria. These criteria are understood to be the same as those mentioned above in relation to queries to the sales database 40.

The coverage of consumer data accessible by the credit bureau 26 is substantially wider than that of the dealer management system 32, and may encompass potential customers who have never made any previous purchases with the dealership 16. In this regard, the selection criteria may be further narrowed to those who are within a predefined geographic distance of the dealership 16. The information available by way of such a pre-screening service include the aggregate balance remaining on any automotive loans, the number of consecutive payments made, the required payment amount for each installment, the number of payments made and the number of payments remaining, the exact or approximate interest rate on the open loans, the date of inception of the loans, and contact information, including one or more of a phone number, mailing address, and e-mail address. Other entities that retain financial data of its customers such as banks, credit unions, and even the financing division of the manufacturer such as the original lender 20 may offer similar collected information.

While the dealership 16 may have contracted with the credit bureau 26 to run routine creditworthiness inquiries for arranging financing for the customer 12, the aforementioned prescreening services may not necessarily come within the scope of such agreements. In this regard, the operator 22 may arrange and negotiate additional agreements with the credit bureau 26 therefor.

Returning to the flowchart of FIG. 3, a new proposed interest rate may be derived in accordance with a step 304, and may be based upon prevailing market rates as provided by the proposed lender 24. The actual interest rate proposed to the customer 12 may differ from that which is offered by the proposed lender 24, as it is expressly contemplated that additional percentage points may be added to improve margins for the dealership 16. The decision on whether or not to add such points may be made based upon a comparison to the original interest rate. For example, it may be determined that reductions of greater than 2% have the greatest likelihood of response from the customer 12. If the proposed interest rate and the original interest rate are greater than that threshold, additional points may be added, though not to an extent that would adjust the difference to less than the aforementioned minimum. Additionally, legal requirements of certain jurisdictions may limit the additional points as well.

Optionally, in addition to deriving a new proposed interest rate, the remaining loan term can be extended to the benefit of the customer 12 by reducing monthly obligations. Similar to adjustments to the proposed interest rate made in the manner discussed above, the remaining duration can be adjusted depending on the reduced periodic payment amount.

From the proposed interest rate, other proposed loan variables that are pertinent to a refinancing decision may be generated in accordance with a step 306. The proposed interest rate is applied to the original loan balance to result in a proposed payoff amount. Along these lines, based upon the proposed payoff amount and the remaining loan term, a proposed periodic payment amount can be generated. Although the proposed lender 24 would prefer to lend only to non-delinquent customers 12, some of the risk involved in offering refinancing offers thereto may be offset by slight increases in the proposed interest rate. Therefore, the prevailing market rates may be adjusted depending on the particular creditworthiness evaluation of the customer 12.

Independently of the aforementioned steps 304 and 306 concerning the generation of proposed loan variables, the method may also include a step 308 of retrieving customer contact data from the customer identification attributes 46 of the retrieved sales records 42. In particular, the name and mailing address may be retrieved, as this is used to address a promotional document 56 to the customer 12. The promotional documents 56 are contemplated to be direct mail pieces, and are generated in a step 310. However, alternative embodiments in which the promotional documents 56 are distributed by electronic modalities such as e-mail may also be utilized. At the most general level, include the selected ones of the original loan variables and the proposed loan variables specific to each customer 12 to which it is addressed. The operator 22 may generate the promotional documents 56 on behalf of the dealership 16, though it is also possible for the operator 22 to merely provide a template or format to the dealership 16, which then populates the applicable fields. This step may also be completed by the dealership 16 independently of the operator 22 without any assistance therefrom.

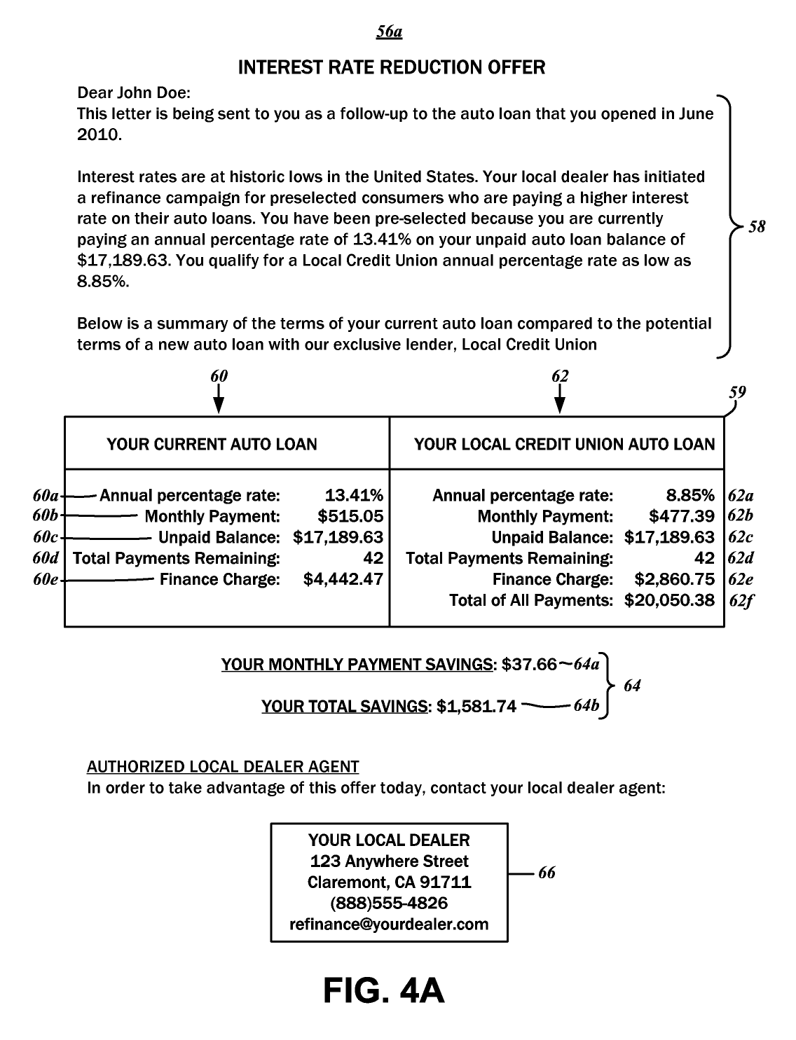

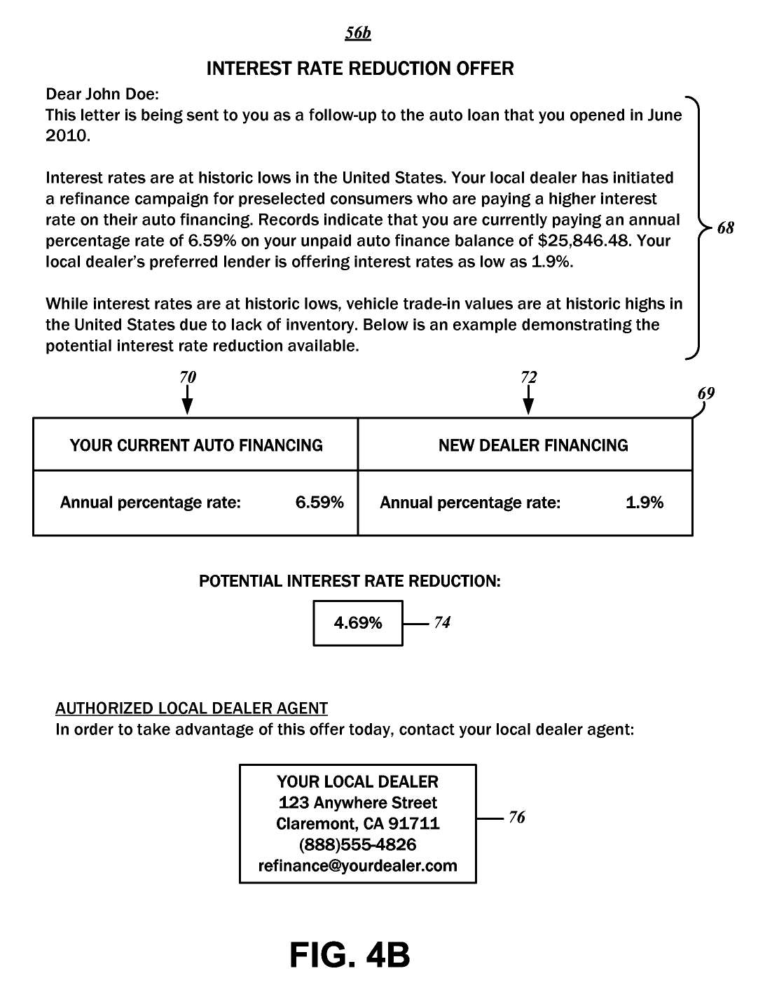

One embodiment of the promotional document 56a is shown in FIG. 4A. As noted above, the promotional document 56 includes the original loan variables and the proposed loan variables for comparison purposes. Generally, the promotional document 56 includes an offer to sell the potential customer a different car with a different interest rate, an offer to refinance an existing open loan at a different rate and/or at a different term, or both. In a narrative section 58, the original interest rate and the original loan balance is mentioned, followed by the proposed interest rate. In a comparison table 59, a first column 60 lists the original interest rate in a first line 60a, the original periodic payment amount in a second line 60b, the original loan balance in a third line 60c, an original remaining payment number in a fourth line 60d, and an original finance charge amount in a fifth line 60e. The second column 62 lists the proposed values for the offered refinanced loan, and lists the proposed interest rate in a first line 62a, the proposed periodic payment amount in a second line 62b, a proposed amount to be financed in a third line 62c, the proposed remaining payment number in a fourth line 62d, a proposed finance charge amount in a fifth line 62e, and a proposed total payment amount in a sixth line 62f. To further drive the point of the possible difference/savings, a summary section 64 shows a periodic payment difference 64a and a total payment difference 64b.

One of the objectives of the promotional document 56 is to encourage its recipient to visit the dealership 16 for further discussion of the proposed offers. To this end, the promotional document 56 includes a dealership contact section 66 that provides the address, as well as a telephone number of the dealership 16.

Another embodiment of the promotional document 56b is shown in FIG. 4B. Its contents are substantially similar to that of the first embodiment of the promotional document 56a, but may be further simplified and including fewer numerical figures. Again, there may be a narrative section 68 that describes the original interest rate and the original loan balance compared to the proposed interest rate. A reduced comparison table 69 may have a first column 70 that shows the original interest rate, and a second column 72 that shows the proposed interest rate. A summary section 64 shows a periodic payment reduction amount that represents the difference between the original interest rate and the proposed interest rate.

The second embodiment of the promotional document 56a may be persuasive toward convincing the recipient to purchase a new vehicle at a lower interest rate, whereas the first embodiment may be persuasive toward convincing the recipient to refinance an existing open loan. However, it will be appreciated by those having ordinary skill in the art that any suitable variation of the promotional documents 56 may be sent to the customer 12, and need not be limited to any particular format or layout shown and discussed above.

Referring again to the block diagram of FIG. 1, a call center 78 may also be included to further promote the refinancing offers. The call center 78 may be directed by or otherwise affiliated with the operator 22, and can accept incoming calls from the customers 12 responding to the promotional documents 56. Alternatively, the call center 78 may initiate phone calls to customers 12 to whom the promotional documents 56 were mailed as a courtesy follow-up. In order to facilitate these phone calls, the operator 22 may provide the dealership 16 with the contact information and loan information contained in the promotional documents 56. The operator 22 may provide instructions to the dealership 16 to obtain a national do-not-call registry subscription account number (SAN) so that the operator 22 may assist with ensuring compliance and in assisting in acquiring the phone numbers. During the course of the conversation, an agent may gather basic information such as names, address, phone number, refinancing terms of potential interest, and new cars of potential interest. Optionally, additional details pertaining to the existing open loan may be obtained, to the extent the customer 12 has them readily available.

Following the information-gathering stage, the call center 78 may set up an in-person appointment for the customer 12 to meet with sales or financing personnel at the dealership 16. Where the call center 78 handles the promotion of refinancing offers for multiple dealerships 16, the customer 12 may be directed to the closest one. The appointment may specify a particular staff member, or any available personnel qualified to discuss and negotiate financing terms. According to some embodiments, the appointment-setting process may be finalized by the dealership 16 after being given the information collected by the call center 78. Subsequent cancellations or modifications to the appointment may also be handled by the dealership 16.

In any case, the collected customer information, also referred to as a lead, together with any appointment information to the extent one is set, may be transmitted electronically to the destination dealership 16. One embodiment contemplates the use of proprietary data communications network systems that interconnect the manufacturer 18 with its affiliated dealerships 16. However, it is possible to transmit such information over conventional e-mail, facsimile, mail, telephone call, and the like instead of a closed system. With the manufacturer 18 being in possession of the potential leads, it is possible to track the progress of the dealerships 16 with each and evaluate activity levels to justify continued use.

The foregoing description of the method for marketing vehicle financing offers is centered around the dealership 16, and to a lesser extent, the operator 22, where the offers, promotional documents 56, telephone calls, and so forth are initiated using information connected closely with the dealership 16. In alternative embodiments, it is possible to use information under the control of the manufacturer 18 and market to customers 12 on a wider scale, possibly nationally, with potential leads being allocated accordingly amongst the multiple dealerships 16. Census information, zip codes, and addresses may be used to identify the dealerships 16 in suitable proximity to the customers 12. The features discussed herein are understood to be adaptable to such alternative environments, and those having ordinary skill in the art will recognize the needed modifications.

The customer 12, with or without setting an appointment, may arrive at the dealership 16 to further negotiate the terms of the refinancing offer indicated in the promotional document 56. In some circumstances, however, the customer 12 may already be at the dealership for other reasons such as vehicle servicing, and various embodiments contemplate utilizing the aforementioned method for marketing vehicle financing offers to him/her, albeit with minor variations. With reference to the block diagram of FIG. 2, as mentioned above, the dealer management system 32 includes the service database 50, the service records 52 of which are also logically linked to the sales records 42 in the sales database 40. It is therefore possible to retrieve information on open existing loans of customers with vehicles undergoing service, and the service department 36 may present to the customer 12 the proposed loan variables generated in accordance with the method discussed above.

Regardless of the way in which the customer 12 is brought in to the dealership 16, upon arrival, a negotiation with personnel from the sales department 34 and/or the financing department 38 follows. The negotiation is for the refinancing of the existing open loan or the purchase of a new car with the prior car 14 being taken on a trade-in and the existing open loan therefor being incorporated into a new loan with preferably more favorable terms. The existing open loan may thereafter be discharged in accordance with conventional practices in the art.

In accordance with another embodiment of the present disclosure, a software application comprising a series of instructions that are executed on the computer terminal 33 and implement a method for generating financing offers is contemplated. More particularly, the application can be utilized as a tool to assist in structuring and closing the refinancing deals. The computer terminal 33 is understood to be a conventional personal computer system/data processing apparatus that is capable of storing and executing those instructions based on certain parameters provided thereto as inputs, and generating certain outputs as results. Details pertaining to the specific hardware devices and operating system software utilized in the computer terminal 33 are omitted, as those will be readily ascertained by those having ordinary skill in the art.

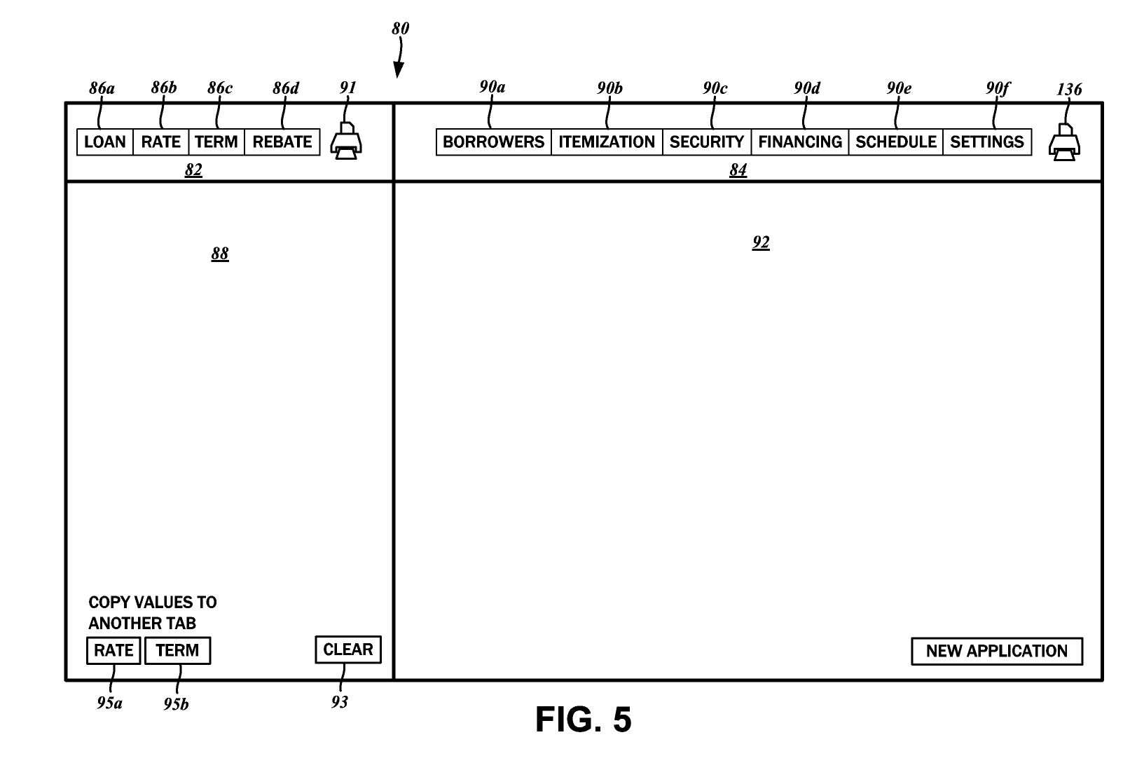

The example screen capture of FIG. 5 illustrates one possible implementation of a user interface 80 of the aforementioned software application. The user interface 80 is generally segregated into a refinancing deal structuring segment 82 and a contract structuring segment 84. The functionality of each segment will be described in turn, as applicable to the method for generating financing offers. The refinancing deal structuring segment 82 includes a plurality of buttons 86 that invoke additional user elements within a first workspace section 88, while the contract structuring segment 84 similarly includes a plurality of buttons 90 that invoke additional user elements within a second workspace section 92.

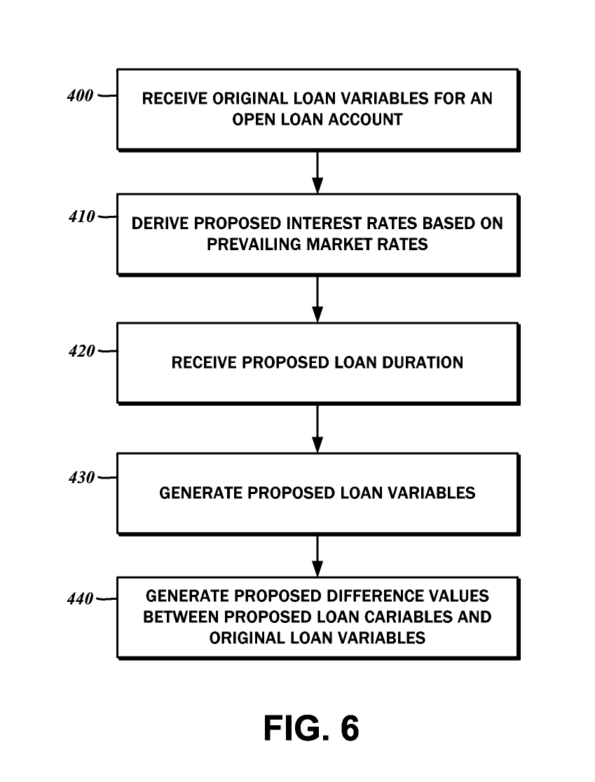

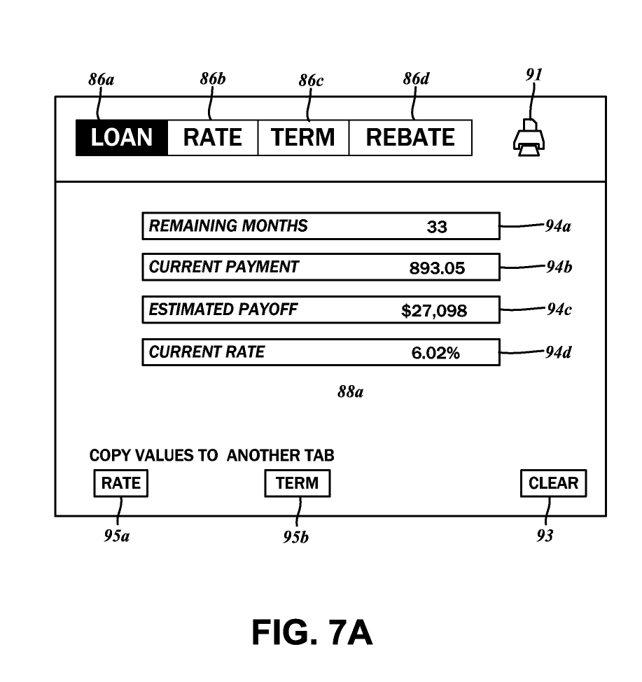

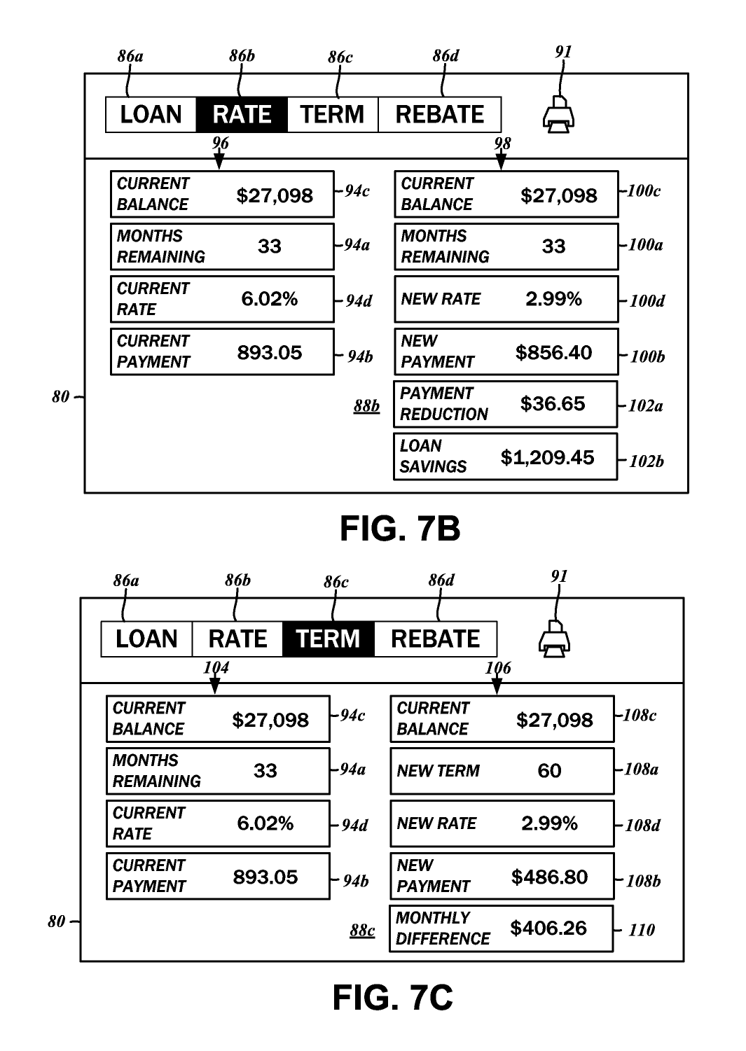

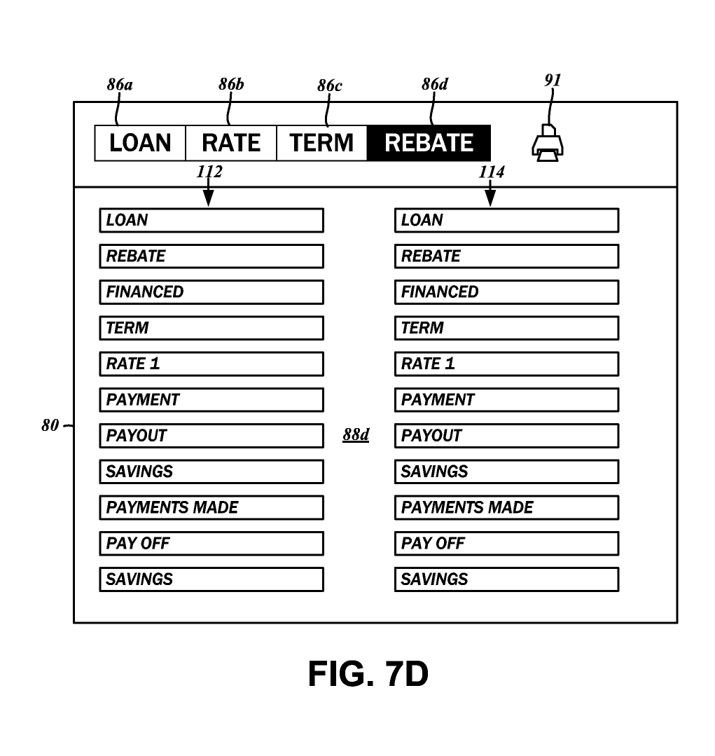

Referring now to the flowchart of FIG. 6, the method begins with a step 400 of receiving original loan variables for an open loan account that is associated with the customer 12. The example screen capture of FIG. 7A illustrates one of the modalities for inputting such original loan variables that is accessible by selecting a loan button 86a. In cases where all of the needed original loan variables are not provided by the customer 12, entry of at least three may enable the automatic calculation of the last. As mentioned above, the original loan variables used for structuring and finalizing refinancing deals include the original periodic (monthly) payment amount, the original loan remaining duration, the original loan balance, and the original loan interest rate. The original loan remaining duration is input into a first text input field 94a, the original periodic payment amount is input into a second text input field 94b, the original loan balance is input into a third text input field 94c, and the original loan interest rate is input into a fourth text input field 94d.

The text input fields 94 are generated on a first workspace 88a that is specific to a selection of the loan button 86a, and may also be referred to as an original loan data input segment. The contents displayed in the first workspace 88a, as with all of the other workspaces discussed below, can be printed by activating a print button 91. The data in the text input fields 94 can be cleared by activating a clear button 93. Although manual input of the original loan variables is contemplated, it is also possible to link the software application directly to the dealer management system 32 for data retrieval purposes.

Along with the calculation of the missing original loan variable, the method may continue with a step 410 of deriving a proposed interest rate based partially upon prevailing market rates. In accordance with one embodiment of the present disclosure, current interest rates are retrieved from a rate sheet that is provided by the proposed lender 24, and as will be described in further detail below, manually entered. There may be a plurality of tiered rates that correspond to the payoff balance of the open loan, as well as a further breakdown of those rates depending on the creditworthiness of the customer 12. In such case, the method may include receiving personally identifying information from the customer 12, and then querying the credit bureau 26 for the credit profile record 28 pertaining to the customer 12 using the personally identifying information. For variations that involve the retrieval of the proposed interest rate from the proposed lender 24 electronically, the query may also include the credit profile record 28, or at least certain excerpts thereof. Since the proposed interest rate is manually entered, however, it is possible for the proposed interest rate to be the same as the original interest rate. This would be useful for demonstrating the effect on the periodic payment amount if only the term of the loan is extended.

Refinancing a loan may oftentimes involve extending the term beyond the original duration to ease the periodic (monthly) payment burdens. As such, the method for generating financing offers to the customer 12 may include a step 420 of receiving a proposed remaining loan duration. Like the proposed interest rate, the proposed remaining loan duration is understood to be manually entered, so for some calculation scenarios where only the effect of modifying the interest rate is to be shown, the remaining loan duration may be kept the same.

Referring back to the flowchart of FIG. 6, the method continues with a step 430 of generating the proposed loan variables based upon the derived proposed interest rate and/or the proposed remaining loan duration. Additionally, there is contemplated a step 440 of generating proposed difference values between certain ones of the original loan variables and the corresponding proposed loan variables. Which of these comparisons are presented to the customer 12 depends on what effect of the refinancing that is to be demonstrated.

As best shown in the example screen capture of FIG. 7B, activating a rate button 86b is operative to invoke a second workspace 88b that includes various output form elements that demonstrate the possible savings to be realized by refinancing to a different interest rate. Similar to the first workspace 88a, the text input fields 94a-94d are included for the input of the original loan variables. Unless the operator of the software application is desirous of re-entering new values, assuming that the values were already entered in connection with the first workspace 88a, it is possible to copy them over to the text input fields 94a-94d, which also serves as output form elements. In one embodiment best shown in FIG. 7A, a copy to rate button 95a could be selected to invoke the copying functionality with the rate/second workspace 88b.

In the example shown, the ordering of the text input fields 94a-94d in the second workspace 88b has changed relative to the ordering of the same in the first workspace 88a, but this is for a more ideal presentation in demonstrating the effects of a lower interest rate. The two variables that would likely remain the same, i.e., the balance of the loan, and the remaining loan duration of the loan, are listed first. In this regard, a first column 96 shows the original loan variables, while a second column 98 shows the proposed loan variables. The proposed balance of the loan is understood to be the same, and shows that no new debt is being incurred. This is displayed on an output form element 100c of the second column 98, in lateral alignment with the corresponding text input field 94c. Similarly, the proposed remaining loan duration is the same, and shows that the debt repayment schedule is not being extended. This is displayed in an output form element 100a likewise of the second column 98, in lateral alignment with the text input field 94a.

The proposed interest rate is different from the original interest rate, and is displayed in an output form element 100d. As noted above, the proposed interest rate could be manually entered, so it is expressly contemplated that the output form element 100d also serves as a text input field and is receptive to user input of data.

With the balance of the loan and the duration being unchanged, but the interest being lowered, the periodic payment amounts decrease. The values for the periodic payment amounts are generated/revised in accordance with the aforementioned step 430. The proposed periodic payment amount is displayed in an output form element 100b in lateral alignment with the corresponding text input field 94b. The portion of the user interface 80 showing the proposed period payment amount, as well as any proposed loan variable, may also be referred to as a proposed loan data output segment.

Although any suitable comparison between any one of the original loan variables and the proposed loan variables may be shown, the embodiment shown in FIG. 7B contemplates a focus on the monetary savings realized from refinancing. Typically, the customer 12 interested in such a refinancing offer may be focused on reducing the overall cost of financing. Accordingly, the proposed difference values generated in step 440 and displayed on the second workspace 88b is the periodic payment amount difference, and a loan savings amount, displayed in output form elements 102a, 102b, respectively. The portion of the user interface 80, and in particular, of the second workspace 88b showing such proposed difference values may also be referred to as a difference output segment.

Invoking a term button 86c is operative to generate a third workspace 88c best shown in FIG. 7C, and may be the preferred, though optional interface for demonstrating the effects of shortening or extending the remaining loan duration. Identical to the second workspace 88b, the third workspace 88c includes text input fields 94a-94d in a first column 104 for the input and display of the original loan variables. Copying over existing values entered in the text input fields 94 of the first workspace 88a into the term/third workspace 88c is possible by activating a copy to term button 95b. The proposed balance of the loan is the same as the original balance of the loan, and its value is displayed in an output form element 108c of the second column 106, in lateral alignment with the corresponding text input field 94c.

It is possible to change the remaining, loan duration relative to the original loan duration to lower the periodic payment amounts. An output form element 108a, which may also serve as a text input field receptive to user input of the revised value of the proposed remaining loan duration, is displayed in the second column 106 in lateral alignment with the corresponding text input field 94a that shows the original loan duration. Along with extending the remaining loan duration, it may be possible to reduce the proposed interest rate as well. Accordingly, there is an output form element 108d displayed in the second column 106 and also is deemed a text input field that is receptive to the proposed interest rate. From the new proposed interest rate and the new proposed remaining loan duration, a new proposed periodic payment amount may be generated in accordance with step 430 as discussed above. The proposed periodic payment amount is displayed in an output form element 108b, in lateral alignment with the corresponding text input field 94b showing the original periodic payment amount.

The typical customer 12 who is interested in refinancing at least based partially on extending the term of the loan, the primary focus may be to ease the monthly payment burden. Accordingly, the third workspace 88c displays an output form element 110 with loan savings amount, which is a comparison between the original periodic payment amount and the periodic payment amount. The application can clearly show, for example, how much additional cash may be available to the customer 12 on a monthly basis by completing the proposed refinancing.

With reference to the screen capture of FIG. 7D, another aspect of the application contemplates a fourth workspace 88d activated by a rebate button 86d for the comparison of a new retail car purchase utilizing different discount types. Specifically, manufacturer rebate could be used, or a lower or subvented interest rate may be used, and the rebate/fourth workspace 88d is understood to demonstrate comparisons thereof. To this end, the fourth workspace 88d includes a first column 112 as well as a second column 114 for making such comparisons. The functionality of the various text input fields 116 are understood to be similar to those discussed above, and will not be repeated.

The data provided to the software application is understood to be utilized for purposes of automatically populating fields in a contractual agreement that is ready to be executed by the respective parties and submitted to the proposed lender 24. The user interface 80 of the presently contemplated software application also includes the second workspace section 92, where additional details necessary for completing the loan application can be specified. The series of buttons 90 can be activated to invoke various workspaces for the input of such details, as will be described in further detail below.

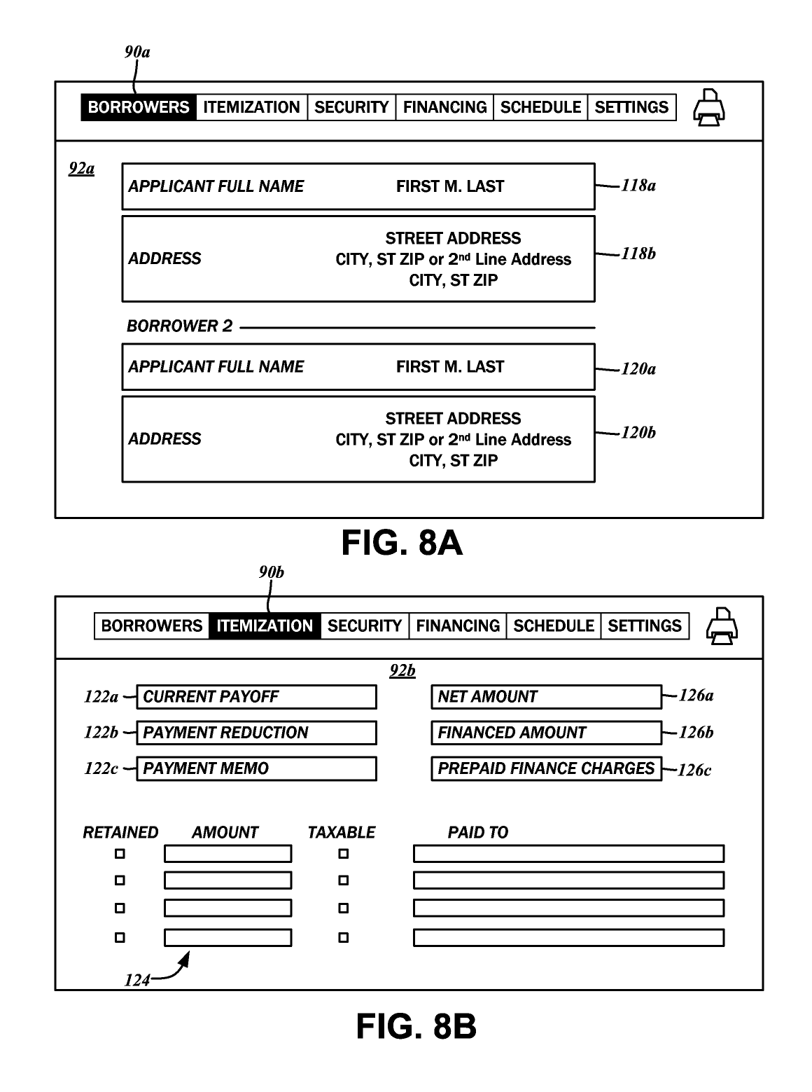

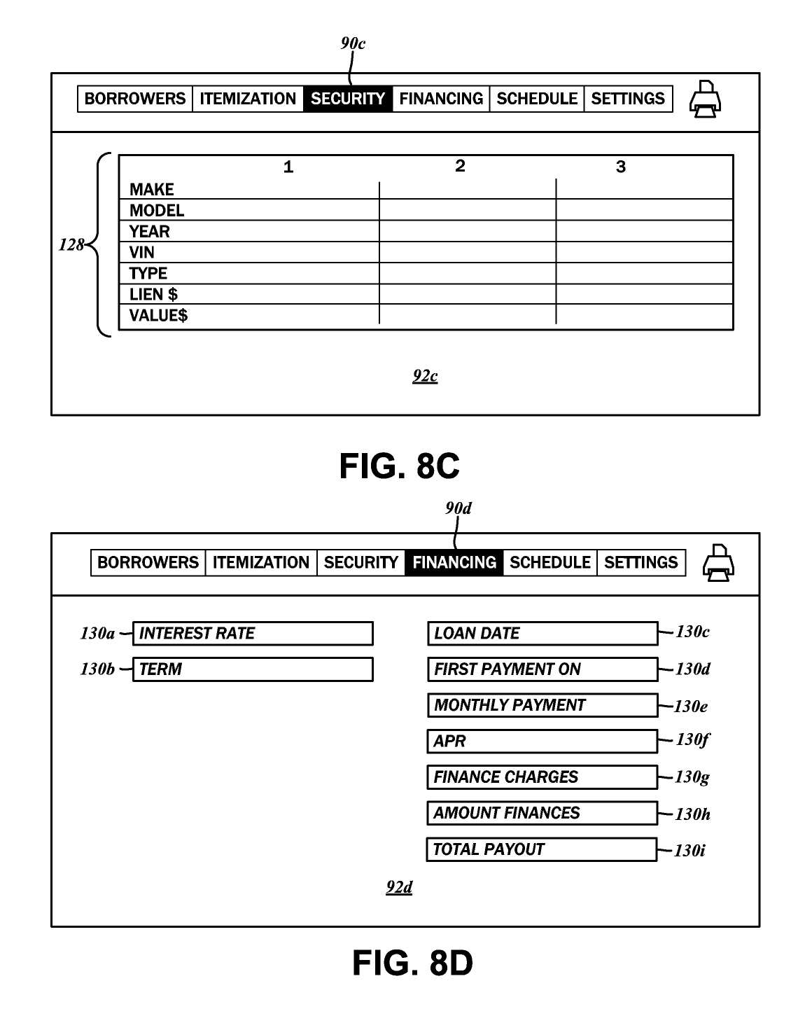

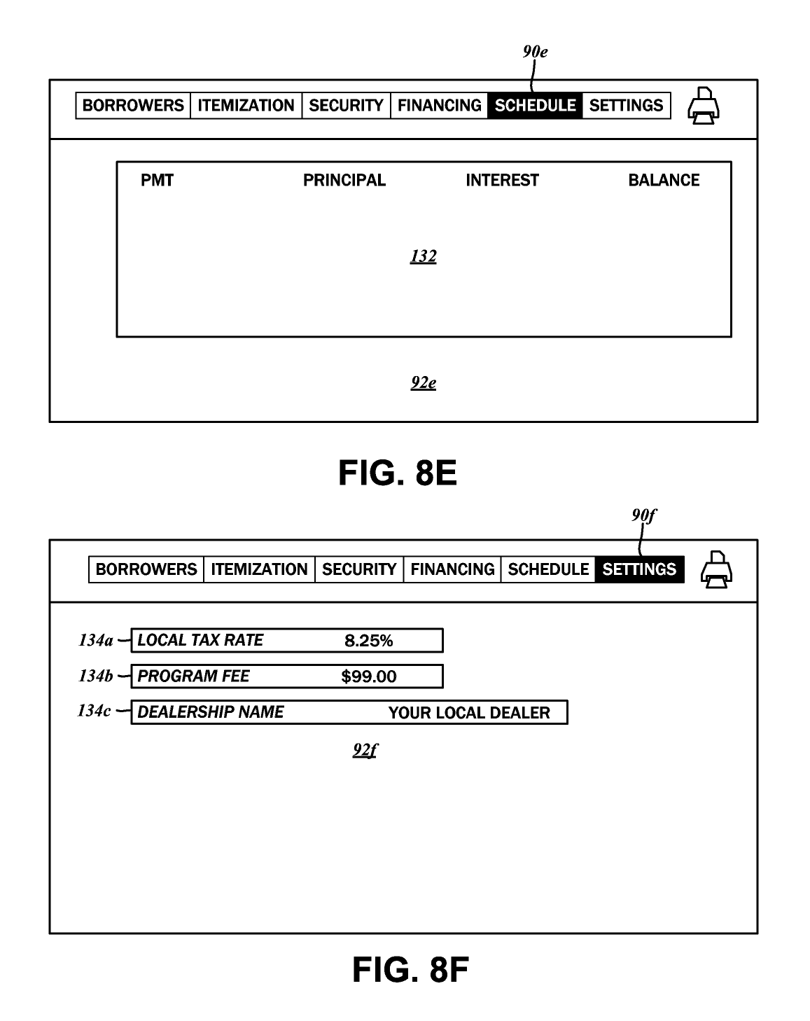

A first button 90a titled “borrowers,” activates a first workspace 92a, an example of which is shown in FIG. 8A. In the first workspace 92a, the name of the customer/borrower 12 is entered into a text input field 118a while the address information therefor is entered into a text input field 118b. To the extent co-signers are part of the proposed loan, the name of such additional customers/borrowers 12 is entered a text input field 120a. The address information is provided in a text input field 120b.

Besides the basic financing terms, there may be various offsets, credits, and the like that must be accounted for. For example, trade-in values, down payments, finance charges, and so forth may be involved. With reference to the screen capture of FIG. 8B, a second workspace 92b may include various fields for itemizing the offsets and credits. The second workspace 92b is understood to be invoked by activating an itemization button 90b. In further detail, the fields include a current payoff amount specified in a text input field 122a, a payment reduction amount for any down payments tendered, can be specified in a text input field 122b, and a payment memo for additional remarks can be provided in a text input field 122c. In a table 124, additional amounts charges incurred by the dealership 16, including such items as licensing and registration fees, satisfaction of the original loan, service contracts, gap insurance policies, alarm systems, service bills, and so forth can be listed. The net amount financed may be shown in an output form elements 126a, 126b, while the prepaid finance charges may be shown in an output form element 126c. Although shown without any values, the output form elements 126 will show the corresponding proposed loan variables upon manual entry or populating from values set within the refinancing deal structuring segment 82.

Next, with reference to FIG. 8C, the security interest of the proposed loan is specified. Considering that the subject of the loan is the car 14, the details thereof, including the make, model, year, vehicle identification number (YIN) type, the identity of the lienholder, and the value (whether market, trade-in, or other metric) are specified in a table 128. Multiple columns are provided for multiple cars 14, as would be necessary for additional purchases. The table 128 is generated in a third workspace 92c that is invoked via a security button 90c.

As shown in FIG. 8D, the specifics of the refinancing deal is specified in a fourth workspace 92d that can be invoked by activating a financing button 90d. In accordance with one embodiment of the present disclosure, the proposed loan variables are used to populate the empty fields in the fourth workspace 92d, though it is possible to manually adjust the values upon import. Other embodiments also contemplate visually copying over values from the first workspace section 88. In further detail, the proposed interest rate is shown in a text input field 130a, while the proposed remaining loan duration pis shown in a text input field 130b. The date on which the loan begins is specified in a text input field 130c, and the new due date for the refinanced loan is specified in a text input field 130d. The proposed periodic payment amount is indicated in a text input field 130e. The calculated annual percentage rate of the loan (the interest rate including all other transactional costs of the loan) is specified in a text input field 130f. The total finance charges of the proposed loan, i.e., the amount charged for interest and other related transactional fees, is specified in a text input field 130g. The total amount financed (the amount loaned, minus the finance charges) is indicated in a text input field 130h, and the total to be paid by the customer 12, including the loaned amount and the finance charges, is specified in a text input field 130i.

Referring now to FIG. 8E, there is a fifth workspace 92e that is activated by a schedule button 90e. This workspace 92e lists the schedule of payments to be made at each periodic interval, and how that payment is allocated with respect to the principal of the loan, the interest on the loan, and the remaining balance following that payment.

A sixth workspace 92f as shown in FIG. 8F and invoked by a settings button 90f, receives inputs for different global settings/terms that are used in every refinance agreement made by the dealership 16. These terms include a local tax rate, specified in a text input field 134a, as well as a program fee charged the customer for participation in the refinancing deal, specified in a text input field 134b. Finally, the name of the dealership 16 is specified in a text input field 134c.

Referring back to the screen capture of FIG. 5, like the refinancing deal structuring segment 82, the contract structuring segment 84 includes a print button 136. The activation of the print button is operative to initiate printing of the contents of the active second workspace section 92. Additionally, clearing existing data entered in the contract structuring segment 84 and starting a new agreement is possible via a clear button 136 located within the second workspace section 92. Again, as indicated above, the data entered via the contract structuring segment is utilized to prepare a contractual agreement that is executed by the customer 12, the dealership 16, and the new lender 24.

The particulars shown herein are by way of example only for purposes of illustrative discussion, and are presented in the cause of providing what is believed to be the most useful and readily understood description of the principles and conceptual aspects of the various embodiments set forth in the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A machine-implemented method for generating financing offers to a customer, the method comprising:
receiving a plurality of original loan variables for an open loan account associated with the customer, the original loan variables including an original periodic payment amount, an original remaining loan duration, an original loan balance, and an original loan interest rate;
deriving a proposed interest rate based partially upon prevailing market rates;
receiving a proposed remaining loan duration;
generating a plurality of proposed loan variables based upon the original loan balance and at least one of the proposed interest rate and the proposed remaining loan duration, the plurality of proposed loan variables including a proposed periodic payment amount and a proposed payoff amount; and
generating proposed difference values from a comparison of the proposed loan variables and the original loan variables, the proposed difference values including a periodic payment amount difference of a comparison between the proposed periodic payment amount and the original periodic payment amount, and a loan savings amount of a comparison between the proposed payoff amount and the original loan balance.

2. The method of claim 1, wherein the proposed payoff amount includes an offset for a trade-in value of a subject of the open loan account and a new sale amount.

3. The method of claim 2, wherein the subject of the open loan account is an automobile.

4. The method of claim 2, wherein the offset includes a down payment tendered for the new sale amount.

5. The method of claim 1, wherein the proposed payoff amount includes an offset for refinancing fees and costs, the proposed interest rate accounting for the offset of the refinancing fees and costs.

6. The method of claim 5, wherein the offset of the refinancing fees and costs includes at least one of a program fees, prepaid finance charges, gap policy charges, servicing charges, taxes, and government fees.

7. The method of claim 1, further comprising:
querying a local dealer management system database for a sales record of the customer, the first sales record being linked to the open loan account associated with the customer and including the plurality of the original loan variables.

8. The method of claim 1, further comprising:
receiving personally identifying information from the customer;
querying a credit bureau database for a creditworthiness evaluation of the customer with the received personally identifying information;
wherein the proposed interest rate is derived at least partially based upon the creditworthiness evaluation of the customer.

9. The method of claim 8, wherein deriving at least one of the proposed interest rate includes:
querying a lender database for the proposed interest rate corresponding to the creditworthiness evaluation and the original loan balance therefor.

10. The method of claim 1, wherein the proposed interest rate is derived from a lender rate sheet.

11. The method of claim 1, wherein the proposed remaining loan duration is user-defined.

12. The method of claim 1, wherein the original loan variables are received via input form elements output on a first segment of a computer generated user interface, each the original loan variables corresponding to a respective one of the input form elements.

13. The method of claim 12, wherein the proposed loan variables are displayed in output form elements output on a second segment of the computer generated user interface, at least one of the proposed loan variables being visually aligned with a corresponding one of the original loan variables whereby a side-by-side visual comparison of the original loan variables and the proposed loan variables is made.

14. The method of claim 13, wherein the proposed difference values are displayed in output form elements output on the second segment of the computer generated user interface.

15. A system for generating financing offers, comprising:
an original loan data input segment generated on a computer user interface and receptive to user inputs, the original loan data input segment including input elements for original loan data of an open loan account including at least one of an original periodic payment amount, an original loan remaining duration, an original loan balance, and an original loan interest rate;
a proposed loan data output segment generated on the computer user interface in response to the input of the original loan data, the proposed loan data output segment including output elements for at least one of a proposed interest rate, a proposed remaining loan duration, a proposed periodic payment amount and a proposed payoff amount; and
a difference output segment generated on the computer user interface in response to the input of the original loan data, the difference output segment including output elements for a periodic payment amount difference and a loan savings amount;
wherein the proposed remaining loan duration and proposed interest rate is derived at least partially from prevailing market rates, and the proposed periodic payment amount and the proposed payoff amount are derived from the proposed interest rate, the original loan balance.

16. The system of claim 15, further comprising:
an offset input segment generated on the computer interface including a first input element for receiving a first offset for a trade-in value of a subject of the open loan account and a new sale amount.

17. The system of claim 16, wherein the offset input segment includes an input element for receiving a second offset for a down payment tendered to the new sale amount.

18. The system of claim 14, wherein the offset input segment includes an input element for receiving refinancing fees and costs.

19. A non-transitory computer readable medium having computer-executable instructions for performing a method for generating financing offers to a customer, the method comprising:
receiving on a computer with input form elements generated on a first segment of a computer-generated user interface a plurality of original loan variables for an open loan account associated with the customer, the original loan variables including an original periodic payment amount, an original loan remaining duration, an original loan balance, and an original loan interest rate;
deriving a proposed interest rate based partially upon prevailing market rates;
receiving a proposed remaining loan duration;
generating a plurality of proposed loan variables based upon the original loan balance and at least one of the proposed interest rate and the proposed remaining loan duration, the plurality of proposed loan variables including a proposed periodic payment amount and a proposed payoff amount;
displaying the plurality of proposed loan variables in output form elements generated on a second segment of the computer generated user interface; and
generating proposed difference values from a comparison of the proposed loan variables and the original loan variables, the proposed difference values including a periodic payment amount difference of a comparison between the proposed periodic payment amount and the original periodic payment amount, and a loan savings amount of a comparison between the proposed payoff amount and the original loan balance.

20. The computer-readable medium of claim 19, wherein at least one of the proposed loan variables is visually aligned with a corresponding one of the original loan variables whereby a side-by-side visual comparison of the original loan variables and the proposed loan variables is made.

21. The computer-readable medium of claim 20, wherein the proposed difference values are displayed in output form elements generated on the second segment of the computer generated user interface.

22. A method for marketing vehicle financing offers to a plurality of customers, the method comprising:
querying a local dealer management system database for a plurality of sales records of customers, at least one of the queried sales records being linked to open loan accounts associated with respective ones of the customers, each open loan account including a plurality of original loan variables including at least one of an original periodic payment amount, an original loan remaining duration, an original loan balance, and an original loan interest rate;
retrieving the open loan accounts with one or more original loan variables matching a predetermined criterion;
deriving a proposed interest rate based partially upon prevailing market rates;
generating a plurality of proposed loan variables based upon the original loan balance and at least one of the proposed interest rate and a proposed remaining loan duration, the plurality of proposed loan variables including a proposed periodic payment amount and a proposed payoff amount;
retrieving customer contact data from the sales records associated with the retrieved open loan accounts;
generating a promotional document for the customers corresponding to the retrieved open loan accounts including the plurality of original loan variables and the plurality of proposed loan variables.

23. The method of claim 22, wherein:
the local dealer management system database is associated with a dealer; and
the promotional document for the customers including a contact information of the dealer.

24. The method of claim 23, wherein each of the promotional documents is addressed with the respective customer contact data associated with the customers, the promotional documents being limited to customers within a predefined geographic distance from the dealer based upon an evaluation of the contact information of the dealer and the customer contact data.

25. The method of claim 24, further comprising:
receiving an appointment request from a one of the customers in response to the promotional document.

26. The method of claim 22, further comprising:
initiating telephone calls to each of the customers with the respective customer contact data using the promotional documents.

27. The method of claim 22, wherein the predetermined criterion is the original interest rate being higher than a predetermined threshold interest rate.

28. The method of claim 22, wherein the predetermined criterion is the original periodic payment amount being higher than a predetermined threshold periodic payment amount.
